(19) United States
(12) Patent Application Publication
(10) Pub. No.: US 2025/0108814 A1
(43) Pub. Date: Apr. 3, 2025

(54) VIBRATION BASED FAULT DIAGNOSTIC SYSTEM FOR STRADDLE-TYPE VEHICLES

(71) Applicant: Robert Bosch GmbH, Stuttgart (DE)

(72) Inventors: Debayan Pradhan, Bengaluru (IN); Jatavalaba Vijay Kumar Srikanth, Canton, MI (US); Faizan Mohammed, Belgavi (IN)

(21) Appl. No.: 18/477,856

(22) Filed: Sep. 29, 2023

(51) Int. Cl. B60W 50/029; B60W 50/02; B60W 50/14

(52) U.S. Cl. CPC B60W 50/029; B60W 50/0205; B60W 50/14; B60W 2050/0215; B60W 2300/36; B60W 2556/45

(57) ABSTRACT

Systems and methods for detecting component faults for a straddle-type vehicle using sensed vibrations. One example system includes a vibration sensor positioned at a first position on the straddle-type vehicle and configured to sense vibrations of the straddle-type vehicle and an electronic processor communicatively coupled to the vibration sensor. The electronic processor is configured to receive, from the vibration sensor, sensor information, determine, based on the sensor information, whether a vibration is present at a predetermined frequency range, and determine, in response to determining that the vibration is present at the predetermined frequency range, whether a characteristic of the vibration exceeds a predetermined threshold. The electronic processor is further configured to, in response to determining that the characteristic exceeds the predetermined threshold, identify a fault with a component of the straddle-type vehicle corresponding to the predetermined threshold and execute a mitigation action based on the fault.

### FIELD

Embodiments and examples presented herein relate to automotive systems diagnostics, in particular to the use sensed vibrations to detect component wear and other conditions for straddle-type vehicles.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a block diagram of a straddle-type vehicle control system, in accordance with some examples.

FIG. 2 schematically illustrates an electronic controller of the system of FIG. 1, in accordance with some examples.

FIG. 3 is a flowchart of an example method for identifying a component fault, in accordance with some examples.

FIG. 4 includes line graphs illustrating aspects of the operation of the system of FIG. 1, in accordance with some examples.

FIG. 5 is a line graph illustrating aspects of the operation of the system of FIG. 1, in accordance with some examples.

FIG. 6 is a line graph illustrating aspects of the operation of the system of FIG. 1, in accordance with some examples.

FIG. 7 is a line graph illustrating aspects of the operation of the system of FIG. 1, in accordance with some examples.

FIG. 8 includes line graphs illustrating aspects of the operation of the system of FIG. 1, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As straddle-type vehicles (e.g., two-wheeled motorcycles) operate on the roadways, they may experience component failure caused by ordinary wear, damage, or other circumstances. Although some vehicles may have one or more sensor systems to detect particular failures with particular components of a vehicle, such systems may not be able to detect an impending failure caused by, for example, physical wear of the component over time. In the particular case of straddle-type vehicles, it may be desirable to predict/detect such impending failures early to avoid failure during operation of the vehicle.

In addition, some noise, vibration, or harshness feedback may indicate a more serious or impending problem, which may eventually render the vehicle inoperable. Accordingly, systems and methods are provided herein for, among other things, detecting and mitigating component wear and failure in straddle-type vehicles.

Examples described herein provide systems and methods for sensing and analyzing vibrations produced by the straddle-type vehicle to detect component wear and failure. In some examples, vibrations are sensed using an accelerometer or another type of vibration sensor. In some aspects, other sensor inputs may be used to detect vibrations or supplement the vibration sensors. Using embodiment and examples presented herein, failures and impending failures can be detected, and mitigation measures can be taken, if necessary, based on the component fault detected. For example, the vehicle can notify its operator, a dealership of the vehicle, a fleet manager, or other entities depending on the nature of the component fault.

One example embodiment provides a system for detecting component faults for a straddle-type vehicle. The system includes a vibration sensor positioned at a first position on the straddle-type vehicle and configured to sense vibrations of the straddle-type vehicle and an electronic processor communicatively coupled to the vibration sensor. The electronic processor is configured to receive, from the vibration sensor, sensor information, determine, based on the sensor information, whether a vibration is present at a predetermined frequency range, and determine, in response to determining that the vibration is present at the predetermined frequency range, whether a characteristic of the vibration exceeds a predetermined threshold. The electronic processor is further configured to, in response to determining that the characteristic exceeds the predetermined threshold, identify a fault with a component of the straddle-type vehicle corresponding to the predetermined threshold and execute a mitigation action based on the fault.

Another example embodiment provides a method for detecting component faults for a straddle-type vehicle. The method includes receiving, from a vibration sensor positioned at a first position on the straddle-type vehicle and configured to sense vibrations of the straddle-type vehicle, sensor information. The method includes determining, with an electronic processor communicatively coupled to the vibration sensor, whether a vibration is present at a predetermined frequency range within the sensor information. The method includes determining, in response to determining that the vibration is present at the predetermined frequency range, whether a characteristic of the vibration exceeds a predetermined threshold. The method includes, in response to determining that the characteristic exceeds the predetermined threshold, identifying a fault with a component of the straddle-type vehicle corresponding to the predetermined threshold. The method includes executing a mitigation action based on the fault.

As used herein, the term “straddle-type vehicle” refers to a motor vehicle, in which the driver occupies the vehicle by straddling it (e.g., a motorcycle). Although straddle-type vehicles are generally two-wheeled vehicles, three and four-wheeled versions exist (e.g., motor trikes, all-terrain vehicles (ATVs), and utility task-vehicles (UTVs)). Although aspects and embodiments are described herein with regard to straddle-type vehicles, this should not be considered limiting. It is possible to apply the examples described herein to other types of two or three wheeled vehicles, including for example, autocycles.

As used herein, the term “component fault” refers to either component failure or a condition of a vehicle component, system, or subsystem, which is out of the acceptable range for the component, system, or subsystem. A non-limiting list of examples of component faults includes engine faults (e.g., a worn drive belt), a low fluid level (e.g., an oil level), and clutch faults. Other component faults may include suspension faults (e.g., worn shocks, ball joints, sway bar mounts), unbalanced wheels, failing wheel bearings, and exhaust system faults (e.g., leaks).

Before any examples are explained in detail, it is to be understood that the examples and aspects presented herein are not limited in their application to the details of constructions and the arrangements of components set forth in the following description or illustrated in the following drawings. Examples presented herein are capable of being practiced or of being carried out in various ways.

It should also be noted that a plurality of hardware and software-based devices, as well as a plurality of different structural components may be used to implement the examples. In addition, it should be understood that examples presented herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software-based devices, as well as a plurality of different structural components may be utilized to implement the invention. For example, “control units” and “controllers” described in the specification can include one or more electronic processors, one or more physical memory modules including non-transitory computer-readable medium, one or more input/output interfaces, and various connections (e.g., a system bus) connecting the components.

It should also be understood that although certain figures presented herein illustrate hardware and software located within particular devices, these depictions are for illustrative purposes only. In some instances, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

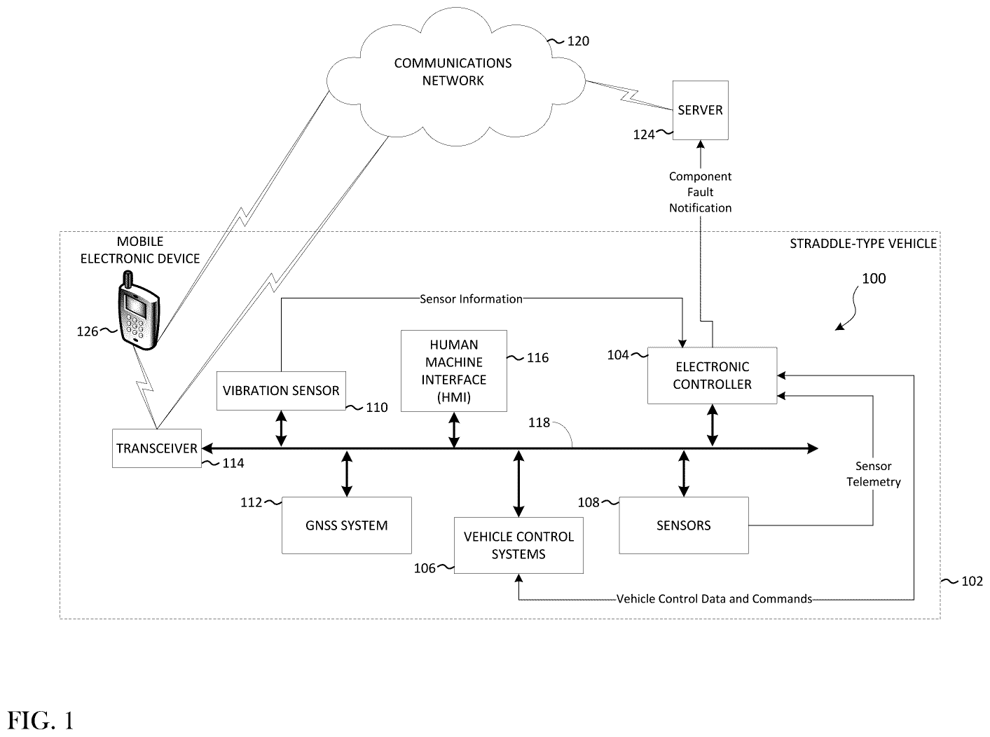

FIG. 1 is a block diagram of one example of a control system 100 for a straddle-type vehicle 102. As described more particularly below, some or all of the vehicle control system 100 may be mounted on, or integrated into, the straddle-type vehicle 102.

In the example illustrated, the system 100 includes an electronic controller 104, vehicle control systems 106, sensors 108, a vibration sensor 110, a GNSS (global navigation satellite system) system 112, a transceiver 114, and a human machine interface (HMI) 116. The components of the system 100, along with other various modules and components are electrically coupled to each other by or through one or more control or data buses (e.g., the bus 118), which enable communication therebetween. The use of control and data buses for the interconnection between, and communication among, the various modules and components would be known to a person skilled in the art in view of the invention described herein. In some instances, the bus 118 is a Controller Area Network (CAN™) bus. In some instances, the bus 118 is an automotive Ethernet™, a FlexRay™ communications bus, or another suitable wired bus. In alternative embodiments, some or all of the components of the system 100 may be communicatively coupled using suitable wireless modalities (e.g., Bluetooth™ or near field communication). For ease of description, the system 100 illustrated in FIG. 1 includes one of each of the foregoing components. Alternative embodiments may include one or more of each component or may exclude or combine some components.

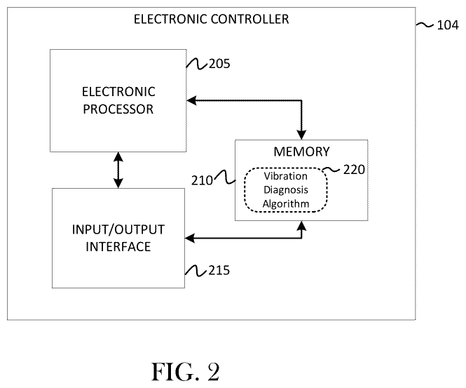

The electronic controller 104 (described more particularly below with respect to FIG. 2) operates the vehicle control systems 106 and the sensors 108 to monitor and control the straddle-type vehicle 102 as described herein. The electronic controller 104 receives sensor telemetry from the sensors 108 and determines control data and commands for the straddle-type vehicle 102. The electronic controller 104 transmits the vehicle control data to, among other things, the vehicle control systems 106 to drive the vehicle (e.g., by generating braking signals, acceleration signals, steering signals) according to input from a driver of the straddle-type vehicle 102 (e.g., through a steering wheel/handlebar system, which is not shown and/or one or more handlebar throttle/pedals of an acceleration/braking system of the straddle-type vehicle 102, which is not shown). The term “operator,” as used herein, generally refers to an occupant of the straddle-type vehicle 102 who is seated in the driver's position (e.g., seated on a seat and straddling the vehicle body), operates the controls of the straddle-type vehicle 102 while in a driving mode, or provides control input to the vehicle to influence the operation of the straddle-type vehicle 102. Although described herein as being manually controlled, it should be understood that, in some embodiments, the straddle-type vehicle 102 may be partially or fully autonomously driven.

The vehicle control systems 106 include controllers, sensors, actuators, and the like for controlling aspects of the operation of the straddle-type vehicle 102 (e.g., steering, acceleration, braking, shifting gears, and the like). The vehicle control systems 106 are configured to send and receive data relating to the operation of the straddle-type vehicle 102 to and from the electronic controller 104.

The sensors 108 determine one or more attributes of the straddle-type vehicle 102 and its surrounding environment and communicate information regarding those attributes to the other components of the system 100 using, for example, electrical signals. The vehicle attributes include, for example, the position of the straddle-type vehicle 102 or portions or components of the straddle-type vehicle 102, the movement of the straddle-type vehicle 102 or portions or components of the straddle-type vehicle 102, the forces acting on the straddle-type vehicle 102 or portions or components of the straddle-type vehicle 102, the proximity of the straddle-type vehicle 102 to other vehicles or objects (stationary or moving), yaw rate, sideslip angle, steering angle, superposition angle, vehicle speed, longitudinal acceleration, and lateral acceleration, and the like. The sensors 108 may include, for example, vehicle control sensors (e.g., sensors that detect throttle position, handbrake position, brake pedal position, steering position, and steering angle), wheel speed sensors, vehicle speed sensors, yaw sensors, force sensors, odometry sensors, and vehicle proximity sensors (e.g., camera, radar, LIDAR, and ultrasonic). In some instances, the sensors 108 include one or more cameras configured to capture one or more images of the environment surrounding the straddle-type vehicle 102 according to their respective fields of view. The cameras may include multiple types of imaging devices/sensors, each of which may be located at different positions on the interior or exterior of the straddle-type vehicle 102.

In addition to the sensors described above, the straddle-type vehicle 102 includes at least one vibration sensor 110. A vibration sensor is a transducer capable of sensing vibrations in a vehicle component, converting the vibrations to electrical signals, and transmitting the electrical signals to the electronic controller 104. In some instances, the vibration sensor 110 is an accelerometer. In some instances, the vibration sensor 110 may be a strain gauge, an eddy-current sensor, a gyroscope, a microphone, or another suitable vibration sensor. In some instances, the vibration sensor 110 may be integrated into another vehicle sensor (e.g., combined with a wheel speed sensor of the straddle-type vehicle 102). In some instances, multiple vibration sensors 110 are used, for example, mounted on each of the straddle-type vehicle's wheels, or at different points on the vehicle's chassis (not shown). In some instances, the vibration sensor 110 is, or includes, a knock sensor positioned proximate to the engine of the straddle-type vehicle 102 for detecting engine knock. In some instances, the vibration sensor 110 is implemented using micro-electrical-mechanical system (MEMS) technology. As described herein, the electronic controller 104 processes the electrical signals received from the vibration sensor 110 to produce vibration information, which may be analyzed to determine a component fault, which (at least in part) is causing at least one particular characteristic of the vibration. In some instances, the vibration sensor 110 includes on-board signal processing circuitry, which produces and transmits sensor information, including vibration patterns thereof, to the electronic controller 104 for processing. As described herein, the electronic controller 104 receives and interprets the signals received from the sensors 108 and the vibration sensor 110 to automatically detect and identify wear and failure in some of the vehicle's components.

In some instances, the system 100 includes, in addition to the sensors 108, a GNSS (global navigation satellite system) system 112. The GNSS system 112 receives radio frequency signals from orbiting satellites using one or more antennas and receivers (not shown). The GNSS system 112 determines geo-spatial positioning (i.e., latitude, longitude, altitude, and speed) for the straddle-type vehicle 102 based on the received radiofrequency signals. The GNSS system 112 communicates this positioning information to the electronic controller 104. The electronic controller 104 may use this information in conjunction with or in place of information received from some of the sensors 108 when controlling the straddle-type vehicle 102.

The transceiver 114 includes a radio transceiver communicating data over one or more wireless communications networks (e.g., cellular networks, satellite networks, land mobile radio networks, etc.) including the communications network 120. The communications network 120 is a communications network including wireless connections, wired connections, or combinations of both. The communications network 120 may be implemented using a wide area network, for example, the Internet (including public and private IP networks), a cellular network, and one or more local area networks, for example, a Bluetooth™ network or Wi-Fi™ network, and combinations or derivatives thereof.

The transceiver 114 also provides wireless communications within the vehicle using suitable network modalities (e.g., Bluetooth™, near field communication (NFC), Wi-Fi™, and the like). Accordingly, the transceiver 114 communicatively couples the electronic controller 104 and other components of the system 100 with networks or electronic devices both inside and outside the straddle-type vehicle 102. For example, the electronic controller 104, using the transceiver 114, can communicate with a remote server 124 to send and receive data, commands, and other information (e.g., component fault notifications). The transceiver 114 includes other components that enable wireless communication (e.g., amplifiers, antennas, baseband processors, and the like), which for brevity are not described herein and which may be implemented in hardware, software, or a combination of both. Some instances include multiple transceivers or separate transmitting and receiving components (e.g., a transmitter and a receiver) instead of a combined transceiver. In some embodiments, the transceiver 114 is or may be part of a connectivity unit of the straddle-type vehicle 102.

The HMI 116 provides visual output, such as, for example, graphical indicators (i.e., fixed or animated icons), lights (e.g., one or more light-emitting diodes (LEDs)), colors, text, images, combinations of the foregoing, and the like. The HMI 116 includes a suitable display mechanism for displaying the visual output, such as, for example, an instrument cluster, a mirror, a heads-up display, a center console display screen such as an infotainment center (e.g., a liquid crystal display (LCD) touchscreen, or an organic light-emitting diode (OLED) touchscreen), or other suitable mechanisms. In alterative embodiments, the display screen may not be a touchscreen. In some instances, the HMI 116 displays a graphical user interface (GUI) (e.g., generated by the electronic controller and presented on a display screen) that enables a driver to interact with one or more control systems 106 of the straddle-type vehicle 102. The HMI 116 may also provide audio output to the driver such as a chime, buzzer, voice output, or other suitable sound through a speaker included in the HMI 116 or separate from the HMI 116 (e.g., in a helmet worn by a driver of the straddle-type vehicle 102). In some instances, HMI 116 provides haptic outputs to the driver by vibrating one or more vehicle components (e.g., the vehicle's handlebars and/or seat(s)), for example, using a vibration motor. In some instances, HMI 116 provides a combination of visual, audio, and haptic outputs.

In some instances, the electronic controller 104, using the transceiver 114, communicates with a mobile electronic communications device 126. In alternative embodiments, the mobile electronic communications device 126, when near to or inside the straddle-type vehicle 102, may be communicatively coupled to the electronic controller 104 via a wired connection using, for example, a universal serial bus (USB) connection or similar connection. The mobile electronic communications device 126 may be, for example, a smart telephone, a tablet computer, personal digital assistant (PDA), a smart watch, or any other portable or wearable electronic device that includes or can be connected to a network modem or similar components that enable wireless or wired communications (e.g., a processor, memory, i/o interface, transceiver, antenna, and the like). In some instances, the HMI 116 communicates with the mobile electronic device 126 to provide the visual, audio, and haptic outputs through the mobile electronic device 126 when the mobile electronic device 126 is communicatively coupled to the straddle-type vehicle 102 (e.g., through an application executed on the mobile electronic device 126, which allows a user to interact with aspects of the control systems of the straddle-type vehicle 102).

FIG. 2 illustrates an example embodiment of the electronic controller 104, which includes an electronic processor 205 (e.g., a microprocessor, application specific integrated circuit, etc.), a memory 210, and an input/output interface 215. The memory 210 may be made up of one or more non-transitory computer-readable media and includes at least a program storage area and a data storage area. The program storage area and the data storage area can include combinations of different types of memory, such as read-only memory (“ROM”), random access memory (“RAM”) (e.g., dynamic RAM (“DRAM”), synchronous DRAM (“SDRAM”), etc.), electrically erasable programmable read-only memory (“EEPROM”), flash memory, or other suitable memory devices. The electronic processor 205 is coupled to the memory 210 and the input/output interface 215. The electronic processor 205 sends and receives information (e.g., from the memory 210 and/or the input/output interface 215) and processes the information by executing one or more software instructions or modules, capable of being stored in the memory 210, or another non-transitory computer readable medium. The software can include firmware, one or more applications, program data, filters, rules, one or more program modules, and other executable instructions. The electronic processor 205 is configured to retrieve from the memory 210 and execute, among other things, software for vehicle control, and for performing methods as described herein. In the embodiment illustrated, the memory 210 stores, among other things, a vibration classification algorithm 220, which operates as described herein to detect and classify vibrations to identify component faults.

The input/output interface 215 transmits and receives information from devices external to the electronic controller 104 (e.g., over one or more wired and/or wireless connections), for example, components of the system 100 via the bus 118. The input/output interface 215 receives input (e.g., from the sensors 108, the HMI 116, etc.), provides system output (e.g., to the HMI 116, etc.), or a combination of both. The input/output interface 215 may also include other input and output mechanisms, which for brevity are not described herein and which may be implemented in hardware, software, or a combination of both.

In some instances, the electronic controller 104 uses one or more machine learning methods to analyze vibration data to identify component faults (as described herein). Machine learning generally refers to the ability of a computer program to learn without being explicitly programmed. In some instances, a computer program (e.g., a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, inductive logic programming, support vector machines, clustering, Bayesian networks, reinforcement learning, representation learning, similarity and metric learning, sparse dictionary learning, and genetic algorithms. Using these approaches, a computer program can ingest, parse, and understand data and progressively refine algorithms for data analytics.

It should be understood that although FIG. 2 illustrates only a single electronic processor 205, memory 210, and input/output interface 215, alternative embodiments of the electronic controller 104 may include multiple processors, memory modules, and/or input/output interfaces. It should also be noted that the system 100 may include other electronic controllers, each including similar components as, and configured similarly to, the electronic controller 104. In some instances, the electronic controller 104 is implemented partially or entirely on a semiconductor (e.g., a field-programmable gate array [“FPGA”] semiconductor) chip. Similarly, the various modules and controllers described herein may be implemented as individual controllers, as illustrated, or as components of a single controller. In some instances, a combination of approaches may be used.

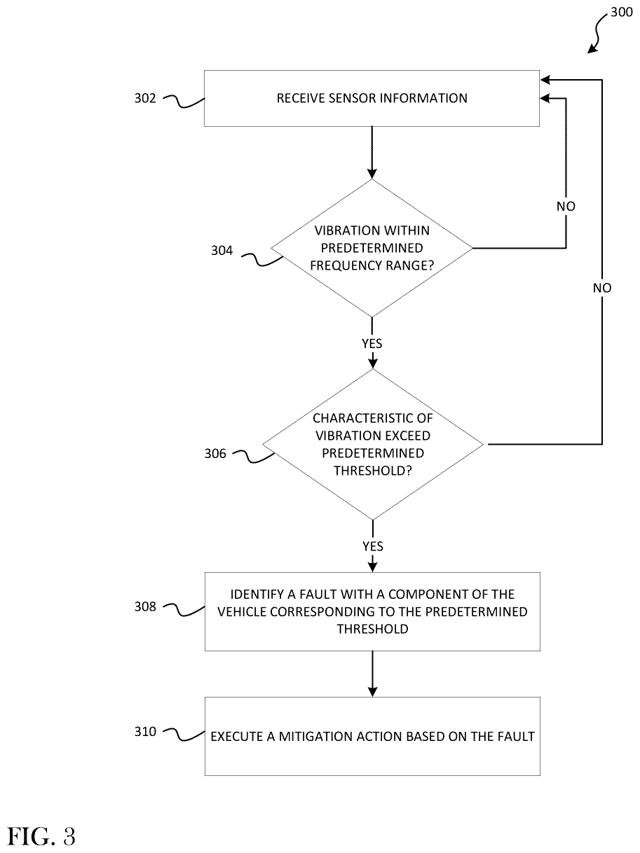

FIG. 3 illustrates an example method 300 for automatically detecting, classifying, and/or mitigating vehicle component faults. Although the method 300 is described in conjunction with the system 100 as described herein, the method 300 could be used with other systems and vehicles. In addition, the method 300 may be modified or performed differently than the specific example provided. As an example, the method 300 is described as being performed by the electronic controller 104 and, in particular, the electronic processor 205. However, it should be understood that in some instances, portions of the method 300 may be performed by other devices or subsystems of the system 100. For example, in some embodiments, at least a portion of the method 300 is performed by the remote server 124.

At block 302, the electronic processor 205 receives sensor information from a vibration sensor (e.g., the vibration sensor 110) positioned at a first position on the straddle-type vehicle 102 and configured to sense vibrations of at least one component of the straddle-type vehicle 102. For example, the electronic processor 205 may receive signals (e.g., via a CAN bus) from an accelerometer positioned on an engine or chassis of the straddle-type vehicle 102. In some embodiments, sensor information is received from more than one vibration sensor 110. The vibration sensors may be positioned at different locations on the straddle-type vehicle 102. In some instances, the electronic processor 205 receives the sensor information continuously. In some instances, the electronic processor 205 receives the sensor information periodically from the vibration sensor 110. In some instances, the sensor information is stored in a buffer or other memory of the electronic controller 104 until it can be processed.

At block 304, the electronic processor 205 determines whether a vibration is present at a predetermined frequency range within the sensor information. In some instances, as explained in more detail below; the particular predetermined frequency range is selected/defined according to a particular component fault, for which the electronic processor 205 is evaluating the straddle-type vehicle 102. The particular predetermined frequency range may correspond to a particular amount of increase (or decrease) in amplitude in one or more frequency components of the vibration due to a particular component fault. For example, when evaluating for a loose drive line (e.g., a drive belt), the predetermined frequency range may be approximately 2 kHz-8 kHz. As another example, when evaluating for a worn clutch, the predetermined frequency range may be approximately 4 kHz-6 kHz. In some embodiments, the predetermined frequency range is selected based on one or more characteristics of the straddle-type vehicle 102 and/or the environment surrounding the straddle-type vehicle 102 (e.g., received from one or more of the vehicle control systems 106 or the sensors 108). Such characteristics may include, for example, engine rotations per minute (RPM), vehicle speed, engine temperature, a current driving mode/gear of the straddle-type vehicle 102, throttle position, engine load, accelerator position, wheel speed, intake air temperature, a road condition (e.g., a road roughness), and the like). In some embodiments, the electronic processor 205 determines whether the vibration is present within more than one predetermined frequency range.

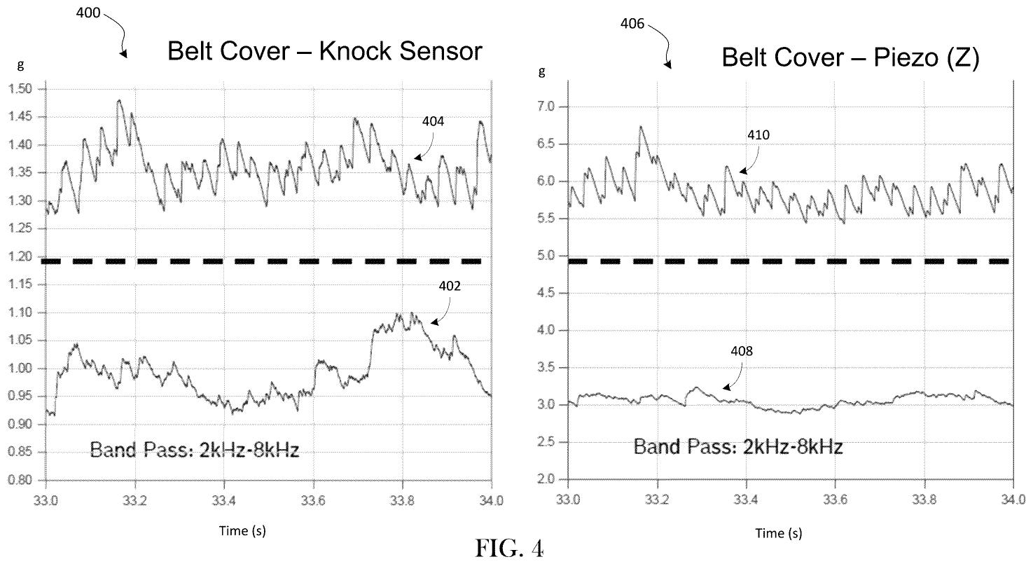

For example, FIG. 4 illustrates the evaluation of vibrations relating to a drive belt. In chart 400, vibrations (measured in g's) are shown over time. In the example illustrated, the vibrations are measured by the knock sensor of the vehicle. Line 402 represents vibrations measured for a drive belt, which is operating at recommended tightness levels. Line 404 represents vibrations measured for a drive belt, which is operating below recommended tightness levels. As illustrated in chart 406, other types of sensors can be used to measure drive belt tightness. For example, in chart 406, vibrations are measured using a piezo sensor. Line 408 represents vibrations measured for a drive belt, which is operating at recommended tightness levels. Line 410 represents vibrations measured for a drive belt, which is operating below recommended tightness levels.

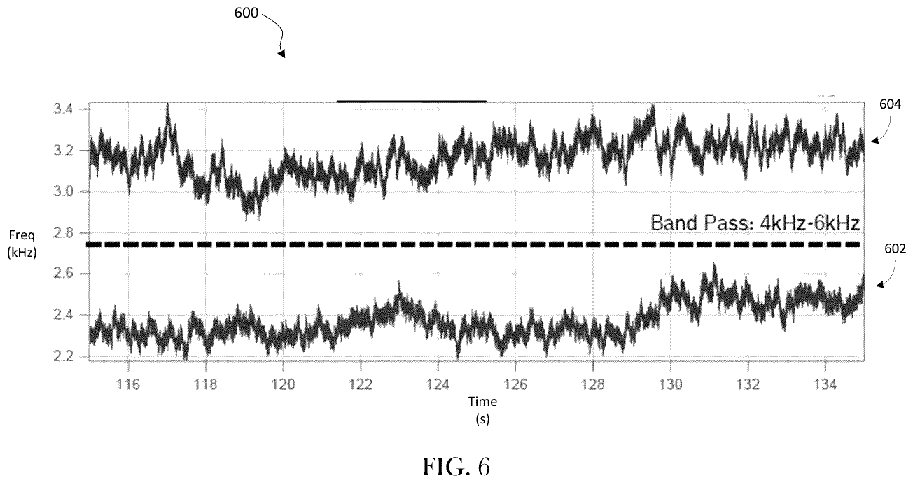

In another example, FIG. 6 illustrates the evaluation of vibrations relating to a clutch. In chart 600, the frequency of vibrations is shown over time. Line 602 represents vibrations measured for a clutch, which is operating within normal parameters. Line 604 represents vibrations measured for a worn clutch.

Returning to FIG. 3, at block 306, the electronic processor 205 determines, in response to determining that the vibration is present at a predetermined frequency range, whether a characteristic of the vibration exceeds a predetermined threshold. The characteristic of the vibration may be, for example, one or more of an amplitude, a frequency, a wavelength, and a phase. As used herein, the term “characteristic of the vibration” may be a single measurement, an average measurement over time, a time series of measurements, and/or a difference in measurements. The predetermined threshold, as explained in more detail below, corresponds to a particular type of component failure.

In some embodiments, the electronic processor 205 compares one or more kinds of characteristics to multiple respective predetermined thresholds. In some embodiments, the electronic processor 205 compares a single kind of characteristic of the vibration to more than one predetermined threshold. In determining whether the characteristic exceeds a predetermined threshold, in some embodiments, the electronic processor 205 determines whether the characteristic of the vibration exceeds the predetermined threshold a predetermined number of times over a time period of operation of the straddle-type vehicle 102.

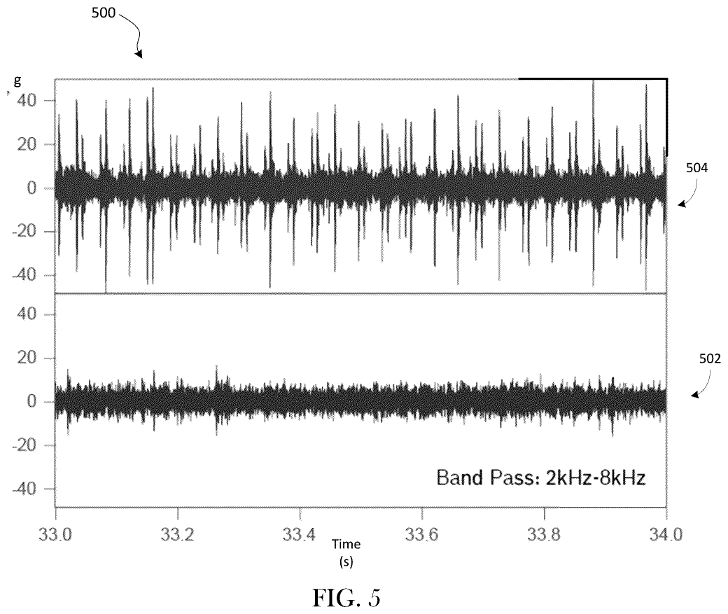

As noted, characteristics other than the amplitude of the frequency may be used to determine a fault. For example, as illustrated in FIG. 5, high levels of amplitude modulation present in the vibrations may be used. FIG. 5 also illustrates the evaluation of vibrations relating to a drive belt. In chart 500, vibrations (measured in g's) are shown over time. In the example illustrated, the vibrations are measured by a piezo sensor. Line 502 represents vibrations measured for a drive belt, which is operating at recommended tightness levels. Line 504 represents vibrations measured for a drive belt, which is operating below recommended tightness levels. As can be seen by comparing the two graphs, the loose belt produces markedly higher amplitude modulation levels.

As illustrated in FIGS. 4-6, in some embodiments, a band pass filter (e.g., 2 kHz-8 kHz) may be applied to the signal received from the vibration sensor prior to analysis.

In some embodiments, the predetermined threshold is selected based on an operating mode of the straddle-type vehicle 102. The operating mode may be, for example, a drive mode or a particular shift gear. The predetermined threshold may be selected based on one or more characteristics of the straddle-type vehicle 102 and/or the environment surrounding the straddle-type vehicle 102 (e.g., received from one or more of the vehicle control systems 106 or the sensors 108). Such characteristics may be similar to those described above with respect to the predetermined frequency range.

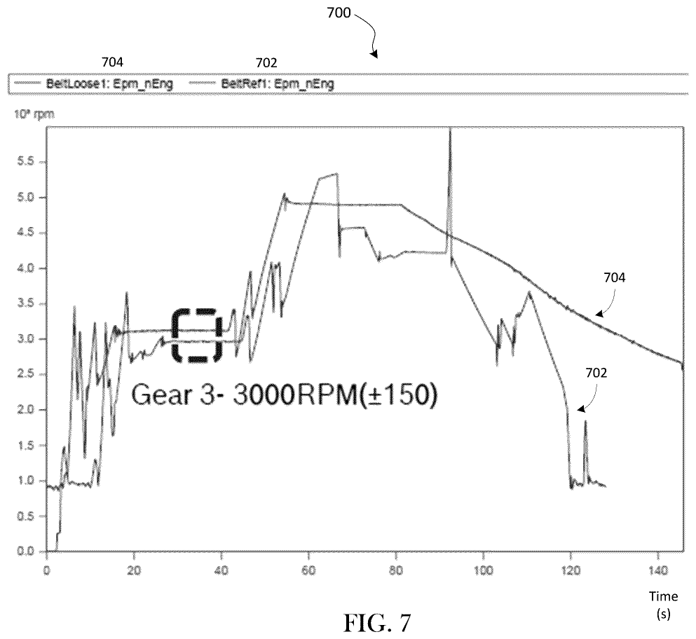

For example, as illustrated in FIG. 7, it may be advantageous to collect vibration readings during a particular range of RPM. FIG. 7 includes a line chart 700, which tracks vibrations over time for a range of RPM. Line 702 represents a reference drive belt and line 704 represents a loose drive belt. As shown in FIG. 7, while in Gear 3 at approximately 3,000 ROM, the two lines are relatively stable. Analyzing vibrations during this operating mode for the straddle-type vehicle would reduce the chance for producing false positives due to the rapid variations present at other times, as illustrated in chart 700.

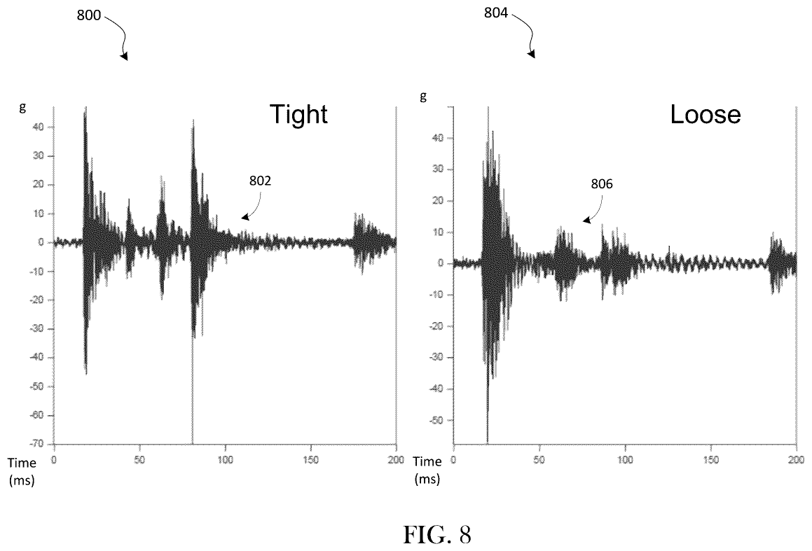

In another example, illustrated in FIG. 8, vibrations detecting during certain operations of the straddle-type vehicle may be used to determine a fault. For example, the impulse caused during a gear shift from neutral to first may be analyzed. FIG. 8 includes to charts 800 and 804. Both illustrate vibrations detected during such a gear shift. Chart 800 includes a line 802, which represents vibrations measured for a drive belt, which is operating at recommended tightness levels. Chart 804 includes a line 806, which represents vibrations measured for a drive belt, which is operating below recommended tightness levels.

In instances where the vibration is not present within the predetermined frequency range, the electronic processor 205 returns to the beginning of the method 300 at block 302.

At block 308, the electronic processor 205 identifies a fault with a component of the straddle-type vehicle 102 corresponding to the predetermined threshold based on the characteristic of the vibration exceeding the predetermined threshold. In some embodiments, in identifying a particular fault, the electronic processor 205 may, as mentioned above, utilize more than one predetermined threshold, and evaluate more than one predetermined frequency range. The particular ranges and/or thresholds may be defined for determining a particular component fault.

In some embodiments, the electronic processor 205, in identifying the component fault, stores the results of the comparisons in the memory 210 as historic comparison results and repeats blocks 302-306 of the method 300 to evaluate second sensor information including a second vibration. The electronic processor 205 may then identify the component fault based on both the historic comparison results (corresponding to the first vibration of the first sensor information) and the second comparison results (corresponding to the second vibration of the second sensor information). The second sensor information may be from the same vibration sensor 110 or from a different vibration sensor located at a second position of the straddle-type vehicle 102. The second sensor information may be evaluated with a different predetermined threshold and/or a different predetermined frequency range than that of the first sensor information. The predetermined thresholds and/or frequency ranges may differ, for example, due to different vehicle characteristics during operation of the straddle-type vehicle 102, as described above. For example, some types of vibrations may be more indicative of a particular component fault when they occur during a braking (e.g., warped rotors) or steering (e.g., worn tie rods) maneuvers while some types of component faults are persistent throughout different operation modes of the vehicle. Thus, to identify a particular component fault, it may be necessary to evaluate more than one vibration at more than one operation mode.

For example, the electronic processor 205 may receive the sensor information at block 302 while the straddle-type vehicle 102 is operating in a first operation mode. The electronic processor 205 may determine whether a vibration is within the sensor information (as explained above in regard to block 304 above) and, in response, store the vibration (and/or the related sensor information) within memory 210. The electronic processor 205 may then receive second sensor information (as described above in regard to block 304) while the straddle-type vehicle 102 is operating in a second mode of operation. The electronic processor 205 then may evaluate the second sensor information to determine whether a second vibration is present within a second predetermined frequency range within the second sensor information. In response to determining that the vibration is present at the predetermined frequency range, the electronic processor 205 may determine whether a characteristic of the second vibration exceeds a second predetermined threshold. The electronic processor 205 may then identify the fault with a component of the vehicle further by determining whether the characteristic of the second vibration exceeds a second predetermined threshold in addition to determining whether the first vibration exceeds the predetermined threshold.

At block 308, the electronic processor 205 executes a mitigation action based on the component fault. In some instances, the mitigation action includes transmitting (e.g., via the transceiver 114) a notification to an operator of the straddle-type vehicle 102, an original equipment manufacturer, a vehicle service center, and/or a dealership of the straddle-type vehicle 102. For example, a suitable network message or API may be used to send a notification that indicates a component fault has occurred, the time and place of the component fault, the type of the component fault, and the like. For example, the electronic processor 205 may send a notification to the remote server 124 regarding the identified component fault and automatically transmit a maintenance request for the straddle-type vehicle 102 to an OEM of the straddle-type vehicle 102, a supplier of the straddle-type vehicle 102, and/or a vehicle service center.

In some instances, the mitigation action includes producing a visual and/or audio alert on a human machine interface of the straddle-type vehicle 102 (e.g., the HMI 116) to inform a driver of the component fault and any other mitigation actions being taken. For example, a display of the HMI 116 may display a message such as “DRIVE LINE LOOSE” or “WORN CLUTCH.” In some instances, the HMI 116 may speak the alerts aloud to the vehicle passenger. In some instances, a combination of alerts may be used. In some instances, the electronic processor 205 may send an alert to the mobile electronic device 126 of the operator (e.g., using the transceiver 114). In some instances, the mobile electronic device 126 executes an application configured to receive and display the alerts. The application may also be capable of sending commands to one or more control systems of the straddle-type vehicle 102. The alert, in some embodiments, may include instructions on how to fix the error or that the error is currently being addressed. In some embodiments, the mitigation action includes placing on or more of the vehicle control systems 106 into a fault mode and/or disabling further use by the operator of the vehicle of one or more vehicle control system(s) 106 affected by the fault. In some embodiments, the mitigation action includes disabling further operational use of the straddle-type vehicle 102 itself. In some instances, multiple mitigation actions are combined.

In some instances, the electronic processor 205 determines the particular threshold(s) and or predetermined frequency ranges for a particular component fault using a machine learning algorithm (e.g., a neural network or a classifier), executable by the electronic processor 205. In some instances, the machine learning algorithm is trained using historical component fault data. For example, the machine learning algorithm is fed training data that includes example inputs (e.g., vibration characteristic data representative of particular component faults) and corresponding desired outputs (e.g., predetermined frequency ranges and/or predetermined thresholds for one or more characteristics of a vibration corresponding to the component fault). The training data may also include metadata for the vibrations of a component fault. Metadata may include, for example, the vehicle speed at the time of the vibration, the model of vehicle in which the vibration was sensed, the operational state of the straddle-type vehicle 102 at the time of the vibration (e.g., braking, accelerating, turning, etc.), and environmental conditions at the time of the vibration pattern (e.g., ambient temperature, ambient humidity, weather conditions, road conditions, etc.). By processing the training data, the machine learning algorithm progressively develops a prediction model that maps inputs to the outputs included in the training data.

In some instances, the electronic processor 205 implements the machine learning algorithm to generate multiple potential component faults (including one or more predetermined frequency ranges and predetermined thresholds thereof) based on the vibration, and determines, for each potential component fault, a confidence score. A confidence score indicates how likely it is that the potential component fault is the cause of the vibration (e.g., how many of the characteristics of the sensed vibration signal meet the particular predetermined threshold(s) and fall within the particular predetermined frequency range(s) for the same type of potential component fault). In such embodiments, the electronic processor 205 identifies the component fault from the plurality of potential component faults based on the confidence score. For example, the potential component fault with the highest confidence score may be selected. In some instances, a confidence score is a numerical representation (e.g., from 0 to 1) confidence. For example, the number of particular predetermined thresholds in which a characteristic of a vibration conditions meets may meet 60% of the predetermined thresholds of a characteristic of a vibration indicative of a potential component fault but may be an 80% match with another potential component fault, resulting in confidence scores of 0.6 and 0.8, respectively.

Optionally, in some instances, the electronic processor 205 assigns a weight to one or more of the potential component faults based on metadata for the vibration and the potential component fault and selects the component fault from the plurality of potential component faults based on the confidence score and the weight. The weight is used to indicate a how significant a particular piece of metadata is to identify a potential component fault as the component fault, relative to the other potential component faults. For example, where both the vehicle experiencing the component fault and a vehicle that produced the training data for potential component fault are the same model, the potential component fault may be assigned a higher weight than would be assigned for the case where the metadata indicates two different vehicle models. In another example, where the vehicle experiencing the component fault was accelerating and the vehicle that produced the training data for potential component fault was decelerating, the potential component fault may be assigned a lower weight that where the metadata indicates that both vehicles were accelerating.

Metadata with higher weights contribute more to the confidence score. For example, a smaller quantity of higher weighted metadata may result in a higher confidence score than a larger quantity of lower-weighted metadata. In such embodiments, the electronic processor 205 determines, for each of the plurality of potential component faults, a weighted confidence score based on the confidence score and the weight. For example, the electronic processor 205 may multiply the confidence scores by the weight assigned. In such embodiments, the electronic processor 205 selects the component fault from the plurality of potential component faults based on the weighted confidence score. For example, the component fault with the highest weighted confidence score may be selected.

In some instances, weights are statically pre-determined for each type of metadata. In some instances, the weights may be determined using the machine learning algorithm. Over time, as matches are determined for vibration patterns and confirmed or rejected by observation, the machine learning algorithm may determine that particular metadata are more determinative to a high confidence score than others, and thus increase the weight for those metadata.

Thus, the embodiments described herein provide, among other things, a control system for a straddle-type vehicle configured to detect and mitigate component faults.

In the foregoing specification, specific embodiments have been described. However, one of ordinary skill in the art appreciates that various modifications and changes can be made without departing from the scope of the invention as set forth in the claims below: Accordingly, the specification and figures are to be regarded in an illustrative rather than a restrictive sense, and all such modifications are intended to be included within the scope of present teachings.

In addition, the phraseology and terminology used herein is for the purpose of description and should not be regarded as limiting. In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a.” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. A device or structure that is “configured” in a certain way is configured in at least that way but may also be configured in ways that are not listed.

Various features, advantages, and embodiments are set forth in the following claims.

What is claimed is:

1. A system for detecting component faults for a straddle-type vehicle, the system comprising:
a vibration sensor positioned at a first position on the straddle-type vehicle and configured to sense vibrations of the straddle-type vehicle; and
an electronic processor communicatively coupled to the vibration sensor and configured to:
receive, from the vibration sensor, sensor information;
determine whether a vibration is present at a predetermined frequency range within the sensor information;
determine, in response to determining that the vibration is present at the predetermined frequency range, whether a characteristic of the vibration exceeds a predetermined threshold;
in response to determining that the characteristic exceeds the predetermined threshold, identify a fault with a component of the straddle-type vehicle corresponding to the predetermined threshold; and
execute a mitigation action based on the fault.

2. The system of claim 1, wherein the characteristic is at least one selected from the group consisting of an amplitude, a frequency, a wavelength, and a phase.

3. The system of claim 1, wherein determining whether the characteristic of the vibration exceeds the predetermined threshold includes determining whether the characteristic exceeds the predetermined threshold a predetermined number of times.

4. The system of claim 1, wherein determining whether the characteristic of the vibration exceeds the predetermined threshold includes determining whether the vibration occurs for a predetermined amount of time.

5. The system of claim 1, wherein the electronic processor is further configured to select the predetermined threshold based on a mode of operation of the straddle-type vehicle.

6. The system of claim 1, wherein the sensor information produced by the sensed vibration of the straddle-type vehicle is received when the straddle-type vehicle is in a first mode of operation and wherein the electronic processor is further configured to:
receive, from the vibration sensor, second sensor information while the vehicle is in a second mode of operation;
determine, based on the second sensor information, whether a second vibration is present at a second predetermined frequency range; and
determine, in response to determining that the vibration is present at the predetermined frequency range, whether a characteristic of the second vibration exceeds a second predetermined threshold,
wherein identifying the fault with a component of the vehicle further includes determining whether the characteristic of the second vibration exceeds a second predetermined threshold.

7. The system of claim 1, wherein the fault is a driveline looseness.

8. The system of claim 1, wherein the fault is a clutch wear.

9. The system of claim 1, wherein the mitigation action is at least one selected from the group consisting of transmitting a notification to a vehicle owner, transmitting a notification to an original equipment manufacturer, transmitting a notification to a vehicle manufacturer, producing an alert on a human machine interface of a mobile electronic device, and producing an alert on a human machine interface of the vehicle.

10. A method for detecting component faults for a straddle-type vehicle, the method comprising:
receiving, from a vibration sensor positioned at a first position on the straddle-type vehicle and configured to sense vibrations of the straddle-type vehicle, sensor information;
determining, with an electronic processor communicatively coupled to the vibration sensor, whether a vibration is present at a predetermined frequency range within the sensor information;
determining, in response to determining that the vibration is present at the predetermined frequency range, whether a characteristic of the vibration exceeds a predetermined threshold;
in response to determining that the characteristic exceeds the predetermined threshold, identifying a fault with a component of the straddle-type vehicle corresponding to the predetermined threshold; and
executing a mitigation action based on the fault.

11. The method of claim 10, wherein the characteristic is at least one selected from the group consisting of an amplitude, a frequency, a wavelength, and a phase.

12. The method of claim 10, wherein determining whether the characteristic of the vibration exceeds the predetermined threshold includes determining whether the characteristic exceeds the predetermined threshold a predetermined number of times.

13. The method of claim 10, wherein determining whether the characteristic of the vibration exceeds the predetermined threshold includes determining whether the vibration occurs for a predetermined amount of time.

14. The method of claim 10, further comprising:
selecting the predetermined threshold based on a mode of operation of the straddle-type vehicle.

15. The method of claim 10, wherein the sensor information produced by the sensed vibration of the straddle-type vehicle is received when the straddle-type vehicle is in a first mode of operation and wherein the method further comprises:
receiving, from the vibration sensor, second sensor information while the vehicle is in a second mode of operation;
determining, based on the second sensor information, whether a second vibration is present at a second predetermined frequency range; and
determining, in response to determining that the vibration is present at the predetermined frequency range, whether a characteristic of the second vibration exceeds a second predetermined threshold,
wherein identifying the fault with a component of the vehicle further includes determining whether the characteristic of the second vibration exceeds a second predetermined threshold.

16. The method of claim 10, wherein the fault is a driveline looseness.

17. The method of claim 10, wherein the fault is a clutch wear.

18. The method of claim 10, wherein the mitigation action is at least one selected from the group consisting of transmitting a notification to a vehicle owner, transmitting a notification to an original equipment manufacturer, transmitting a notification to a vehicle manufacturer, producing an alert on a human machine interface of a mobile electronic device, and producing an alert on a human machine interface of the vehicle.

19. A non-transitory computer-readable medium storing instructions that, when executed by a computing device, cause the computing device to perform operations comprising the automated method of claim 10.
